(19) United States
(12) Patent Application Publication
(10) Pub. No.: US 2015/0278941 A1
(43) Pub. Date: Oct. 1, 2015

(54) LOAN AUTOMATION SYSTEM

(71) Applicant: WONGA TECHNOLOGY LIMITED, Dublin (IE)

(72) Inventors: Daniel Hegarty, London (GB); Errol Damelin, London (GB)

(73) Assignee: WONGA TECHNOLOGY LIMITED, Dublin (IE)

(21) Appl. No.: 14/226,072

(22) Filed: Mar. 26, 2014

(51) Int. Cl. G06Q 40/02

(52) U.S. Cl. CPC G06Q 40/025

(57) ABSTRACT

A system, process and non-transitory computer readable storage medium are used to automatically determine whether to provide a loan. In accordance with the loan process, input data comprising at least a request for a loan and an identity of the loan applicant is received from a remote user device operated by, or on behalf of, the person or legal entity applying for a loan. In response to this request several pieces of data are calculated, determined and/or obtained. These include at least a trust rating related to the applicant, a first type of external data related to the credit worthiness of the loan applicant and a second type of data determined by monitoring online usage by the user of the user device. The process then automatically determines whether to provide the requested loan using at least the trust rating and the first and second types of external. If the loan is approved, instructions are sent to transfer the loan to a bank account. When the loan repayment is due, one or more debit requests for repayment are automatically sent to until the loan amount has been returned.

### BACKGROUND OF THE INVENTION

This invention relates to methods and systems for automation of financial lending transactions and in particular to automated and fully automated online loans.

Computerized lending or loan systems, include any systems in which a loan applicant initiates a request to a computerized system and the request is fulfilled in some way by a system response. Computerized systems such as this typically provide a certain level of automation, but at some point require human intervention and thereby reduce efficiency and speed of the lending process.

A particular example of is the field of financial lending services provided by communication over the Internet. The volume of requests made by applicants by way of hits on websites can be very high volume leading to difficulties in determining whether or not a loan should be provided to a given applicant. The loan in such systems is typically a short term loan for a low amount. In such systems there is a need to determine case by case whether a user request should be fulfilled.

### SUMMARY OF THE INVENTION

We have appreciated that high volume online systems require improvements such that applicant requests may be fulfilled and processed to completion without, or at least substantially without, human intervention. In particular, we have appreciated that, in online systems, the model by which loan decisions should be made should differ from conventional non-online techniques. In this regard, online loans include those provided to individuals and those provided to legal entities such as corporations, partnerships, charitable organizations and limited liability entities.

### BRIEF DESCRIPTION OF THE DRAWINGS

A preferred embodiment of the invention will now be described in more detail by way of example with reference to the drawings, in which:

FIG. 1: is a functional diagram of the key components of a system embodying the invention;

FIG. 2: is a flow diagram showing the main operational steps of a system embodying the invention;

FIG. 3: shows example sources of external data;

FIG. 4: shows example sources of monitoring online usage; and

FIG. 5: is a flow diagram of an example monitoring of online usage;

FIG. 6: shows a process for producing a trust rating;

FIG. 7: shows a process for retrieving a second type of data;

FIG. 8: shows a process for automatically determining whether to provide a loan;

FIG. 9: shows a process for instructing the sending of a loan amount; and

FIG. 10: shows a process for initiating debit requests.

### DETAILED DESCRIPTION OF THE PREFERRED EMBODIMENTS

The preferred embodiment disclosed herein is a computer system operating processes to provide a fully automated online loan service. The provision of the loan is fully automated in the sense that the decision whether to provide a loan and the payment of a loan amount do not require human intervention. The system is arranged to receive a loan request from a loan applicant using a user device, to process that request including carrying out a decision process to determine whether to provide the requested loan and, if the loan is to be provided, providing an amount directly to a bank or other account associated with the applicant and subsequently obtaining repayments using debit requests. As already noted, the process may operate automatically and without human intervention. The loan may be a specified amount for a fixed period or for a variable period. The loan may also be a line of credit which can be decided and then drawn down as and when requested by the applicant.

The request for a loan may be submitted from a user device. User devices include, but are not limited to, personal computers, smart phones, tablets, wearable devices and other wired or wireless devices by which an applicant may connect to a remote server over a network such as the Internet. The embodiment carries out a decision making process to determine whether to provide the requested loan using at least a first type of data related to the creditworthiness of a loan applicant and a second type of data determined by monitoring online use by the applicant using the user device. This approach is unique in providing a fully automated online loan system.

Whenever a decision is taken to lend money for a period of time, the lending organisation will make a decision based on at least two important factors, namely affordability risk and fraud. An assessment of risk involves determining the ability of the borrower to repay and therefore the likelihood that they will successfully repay the loan. An assessment of fraud involves various checks to try and determine if the person (whether a real person or a corporate) is who they say they are and, accordingly, whether there is any clearly detectable intention to borrow money with no intention of repaying. In order to assess risk related to affordability of a loan and risk due to fraud, a scorecard approach is often used by banks and other lending institutions in order to evaluate whether to provide a given loan.

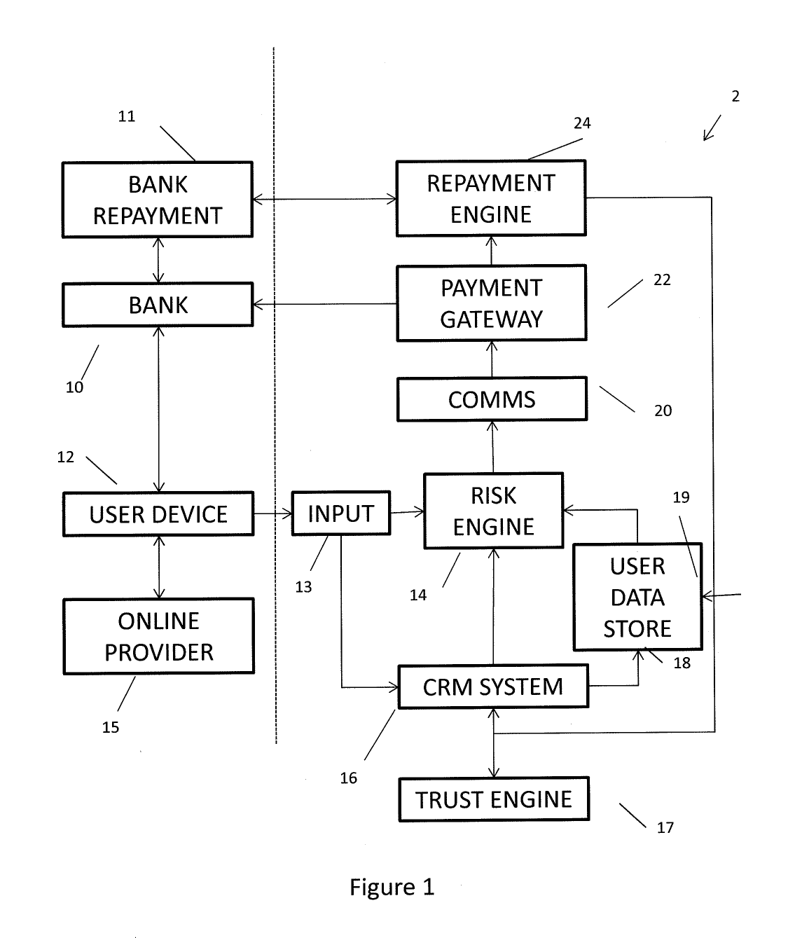

Systems and methods of this disclosure appreciate that there are unique problems and also opportunities in determining how to assess both fraud and affordability risk for automated lending. Systems and methods of this disclosure, therefore, include a new risk engine (software running on more or more processors) which will now be described in relation to a system embodying the invention as shown in FIG. 1.

The embodiment shown in FIG. 1 comprises a remote service 2 comprising processors, memory and executable code which when executed may automatically deliver a loan in response to a request from a user device 12 and to reclaim the loan at an appropriate time.

A user device 12, of an applicant, such as a PC, tablet, smartphone, wearable device or other mobile device is connected by a wired or wireless communication path to the remote service 2. The remote service or system 2 is typically provided by a lending institution and provided as a collection of programmatic units on a server system, but may be deployed across multiple such server systems. A request for a loan to be paid may be transmitted from the user device 12 to an input 13 of the system 2 and passed to a risk engine 14. The risk engine has logic to determine whether a loan should be delivered in response to the request. The risk engine 14 has inputs to gather data from the input 13, a Customer Relationship Management (CRM) system 16 and third party sources aggregated in a third party database 18. The CRM system 16 holds data related to loan applicants based on prior use of the system by those applicants and includes data retrieved from a trust engine (again, software running on one or more processors) 17 that determines a trust rating for each repeat applicant. Using this collection of information, the risk engine 14 determines whether a loan should be provided and, if so, for what amount. The risk engine will be described further later.

If the risk engine 14 determines that the loan request should be fulfilled, a message is asserted to communication unit (COMMS) 20 which instructs a payment gateway 22 to transmit the loan amount to a bank 10 and to the specific bank account number specified by the applicant. When the period for returning the loan expires, a repayment engine (again, software running on one or more processors) 24 sends a first request to retrieve payment of the loan from a debit facility shown as a bank repayment arrangement 11. The debit facility may be a debit card of the applicant that is linked to the bank account of the applicant or a debit arrangement or some other form. The repayment engine 24 determines if the return payment was received. If not, successive requests for portions of the loan are initiated by the repayment engine 24 until the full amount of the loan is returned. The request for repayment of the loan may be at one specified date or may be spread across multiple dates depending upon the type of loan.

An important aspect of the loan processing platform described is the extent of its automation; an applicant can apply for a loan online by wired or mobile device, and the system will analyze a range of different data sources in real time, make a lending decision, transfer funds to the applicant, communicate with the borrower, collect the funds back at the end of the loan. In addition, the system can manage key aspects of the arrears/repayment plan in a fully compliant fashion with its regulatory regimes in multiple jurisdictions without human intervention. The applicant for the loan facility may be an individual or a legal entity. The risk processes may differ depending upon whether the applicant is a business an individual or other legal entity. In addition, the risk processes may differ by jurisdiction and currency.

Two types of loan are preferably provided by the system (other types of loans can be provided in lieu of or in addition to these preferred loan types). A first type of loan is a fixed term loan in which an amount is drawn down and an agreed amount of interest paid after a period. This first type of loan includes a loan with a single repayment amount at the end of a term, or with repayment amounts spread over a number of installments. The second type of loan is the provision of a line of credit, the amount of which may be decided and then amounts drawn against this line of credit by the applicant at the time the credit decision is made or at later times. In this second type of loan, the repayments may be calculated and taken periodically, such as weekly.

The actual sign up of process for a loan request and the drawing down of a loan amount may be separate steps undertaken at different times. For example, a loan request may be made by a new user of the service and the actual loan amount drawn down at that time, or a later time. Similarly, a line of credit may be determined and then the actual request to draw against the line of credit may be received later. In all cases, the decision, payment and repayment is all undertaken without, or substantially without, human intervention.

The main components that together allow the system to operate will now be described in more detail, referring again to FIG. 1.

The risk engine 14 is arranged to automatically make the ultimate decision about whether or not to lend to the applicant. It uses dynamic logic to decide which data sources to query for each applicant, including third party sources, which may be aggregated in a user data store 18, and which may be enriched with analysis of history of lending data within the system. Using this data the risk engine 14 automatically makes a lending decision.

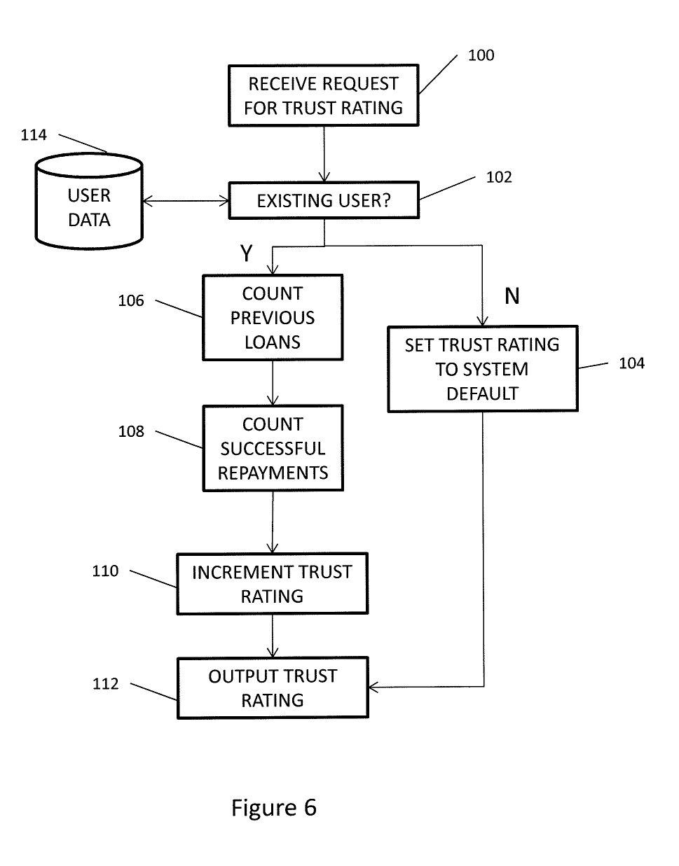

The main source of data for the risk engine 14 is preferably applicant data related to the specific applicant retrieved from the Customer Relationship Management (CRM) system 16 mentioned above. This stores data related to current or previous loans for the applicant. If the applicant is a new applicant, then such CRM data will not be available. The CRM system also stores a trust rating provided by a trust engine 17 that provides a calculated trust rating for an existing applicant of the system or a default trust value for a new user. The production of a trust rating is described later in relation to FIG. 6.

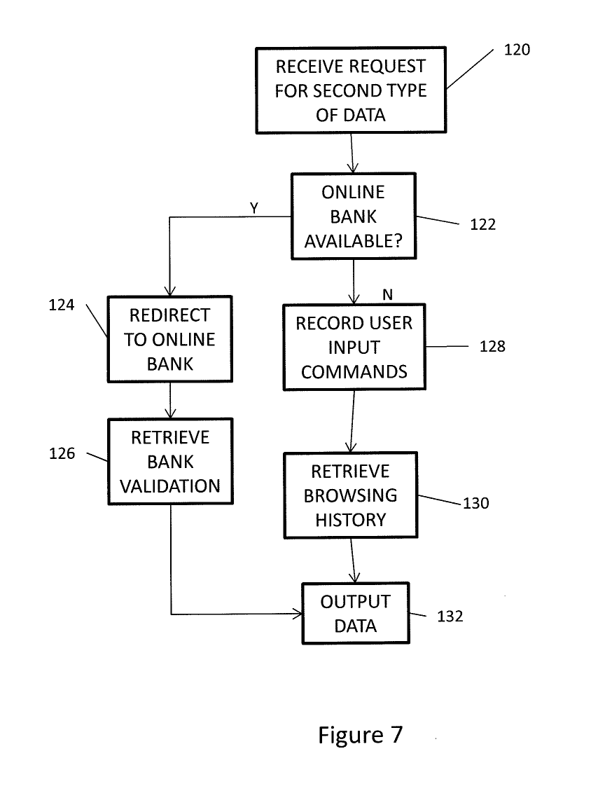

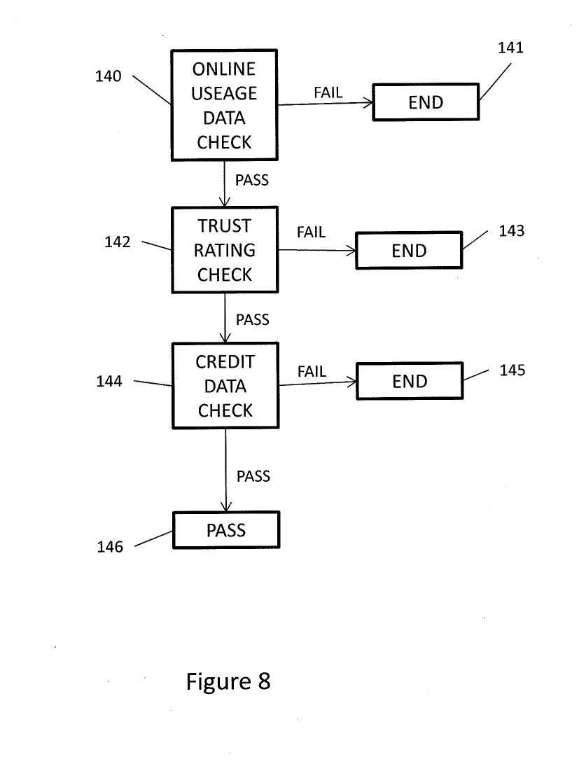

Another significant source of data is obtained from outcomes of previous loans to all users provided as feedback from the repayment engine 25 to the CRM system 16. The outcome of each loan, such as whether repaid on time or late and other data related to each applicant is held within the CRM system and provided to the aggregated user data source 18. The risk engine 14 can query this data source when determining whether to provide a loan to a new applicant using techniques such as applicant profiling, pattern matching or other ways of devising the likelihood that a applicant will repay based on previous experience for similar applicants. A key advantage of the system is that the system may operate without requiring additional externally retrieved data for the specific applicant from third party sources. However, if such data is desired it may be retrieved by an external connection 19. This may be considered as a first type of data. In addition, a second type of data is retrieved related to online usage. The step of retrieving this type of data is described in more detail in relation to FIG. 7. The step of automatically determining whether to provide a loan in accordance with sources of data is described further later in relation to FIG. 8.

The payment gateway 22 generally manages the routing of funds from lender bank accounts to the borrower, using a range of smart routing technology (and reconciliation engines to check that payments have gone through). A standard payment request is typically executed through the external banking gateway used by the system, in which a batch file is uploaded from the repayment engine to a bank at regular intervals and executed within regular windows, such as every 15 minutes, other periods during the day or at the end of day. The gateway facilitates routing to a number of different banks.

The manner in which payments are batched for applicants may vary by jurisdiction. Where the banking infrastructure is such that it would not otherwise meet the timescale desired (typically 15 minutes), the payment gateway 22 is innovative in how it transfers funds quickly to borrower's accounts. In an arrangement for a jurisdiction where there a small number of dominant banks, the system has access to transactional bank accounts with each such bank, and payment is routed by the payment gateway through the most appropriate bank depending on the identity of the recipient bank 10. Using this approach delay is minimised because same bank payment is quicker than inter-bank payments.

At the end of each loan, the funds (principal+interest+any relevant fees/charges/penalties) need to be collected from the borrower. The repayment engine is a smart collections engine that collects funds back from the borrowers' bank accounts at the end of the loan and during the arrears/repayment periods. It has smart algorithms governing how much money to collect when and from which account.

A standard repayment request is first sent to the external bank payment gateway 11 to request funds from the relevant debit card or directly from a bank account as appropriate—and if this is successful, then the borrower's account is credited and settled. If the payment request fails, the account is put into an arrears process, and a sophisticated electronic collections system kicks in. A core component at the heart of this is a collection routine that calculates the optimal amounts to try reclaim from the debit card in a set of progressive collection requests. Variables include deciding upon the time of day/day of month to attempt to reclaim funds and the amount to try reclaim. This can depend on when the borrower is likely to be paid, have money in his/her/it's bank, when successful payments were previously reclaimed from the particular customer (or other customers with similar profiles in various respects), and so on. As this process is automatic, the whole system is able to operate at a high volume of collection attempts each month. Sophisticated reconciliation logic is also applied to inbound payments, in particular early repayments which can be initiated by applicants from their online banking accounts or by other repayment methods.

The trust engine 17 maintains a rating for each customer and this changes based on the repayment behaviour/number of loans taken and other factors. For a new applicant, a default trust rating is used. For a repeat applicant, the trust rating may be varied based on factors including prior behavior, such as repayment of loans or on a profile of the applicant based on behaviour of similar applicants.

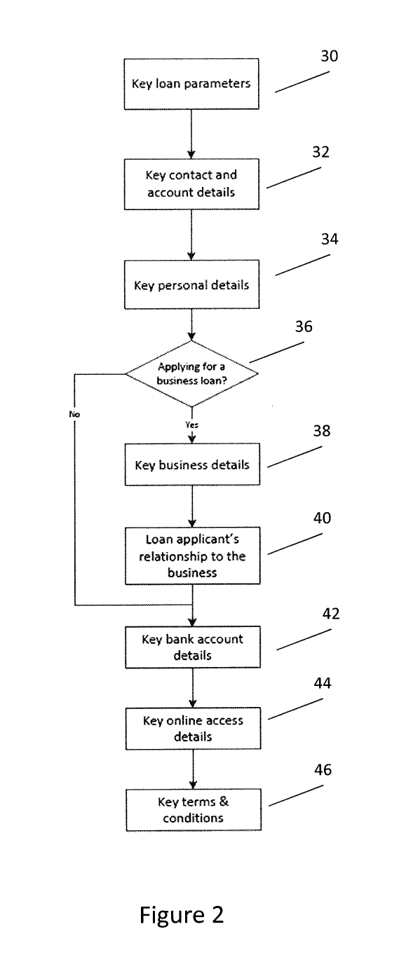

FIG. 2 shows the presently preferred process for applying for an online loan and will now be described before returning to more details of the risk engine 14. The process is shown as a flow diagram as a sequence of steps for simplicity, but for the avoidance of doubt the precise order of capturing the data is not essential and other procedures may be appropriate. At an input step 30, key loan parameters are entered by an applicant using their user device including data such as the amount of loan requested, the length of time the loan is required for and the purpose of the loan. At a second input step 32, key contact and account details are requested and the user may input these such as email, password, contact numbers and the like which enables the system to retrieve either an existing account for the applicant, or to create a new account. At a third input step 34, further key personal details are requested by the system and again input using the user's device, for example the applicant's title, name, data of birth, residential status, marital status, number of dependents, social security number and employment status. In the event that the applicant has obtained a loan from the loan provider on a prior occasion, this step may be omitted as this data can be retrieved using the account information entered at step 2 above.

The system may be used to request either a personal loan (for an individual) or a business loan (for a legal entity) and the system is able to provide either of these using the risk engine 14. At decision step 36, an applicant may select to apply for a business loan or a personal loan. If the applicant is applying for a business loan, additional input is requested at step 38 in the form of key business details such as the name of the business, business address, business type, average turnover, tax ID, employer ID and business telephone number. As with a personal loan, if this information has already been provided at a prior time, then it may be retrieved from the system using prior account details. As a security step, some of the information could be retrieved using account details and some could be requested again to provide verification.

At input step 40, the loan applicant is requested to indicate their relationship to the business, such as a role in the company as an employee or director or other relationship to the company such as ownership of the company, percentage ownership or authority to bind the company. As with the key business details, if the loan applicant's relationship to the business is already stored against an account with the system, then this can be retrieved rather than requesting this to be entered again.

Optional further inputs are requested at steps 42 and 44 including key bank account details such as the name of the bank, account number and routing sort code asl well as key online access details such as online bank account access and online accounting platform. In a final acceptance step 46, the applicant is requested to accept terms & conditions using their user device.

The process described in relation to FIG. 2 captures data necessary for the loan application which is used as part of the decision process. However, the system of this disclosure provides two additional types of data by which the risk engine may determine whether to provide the requested loan.

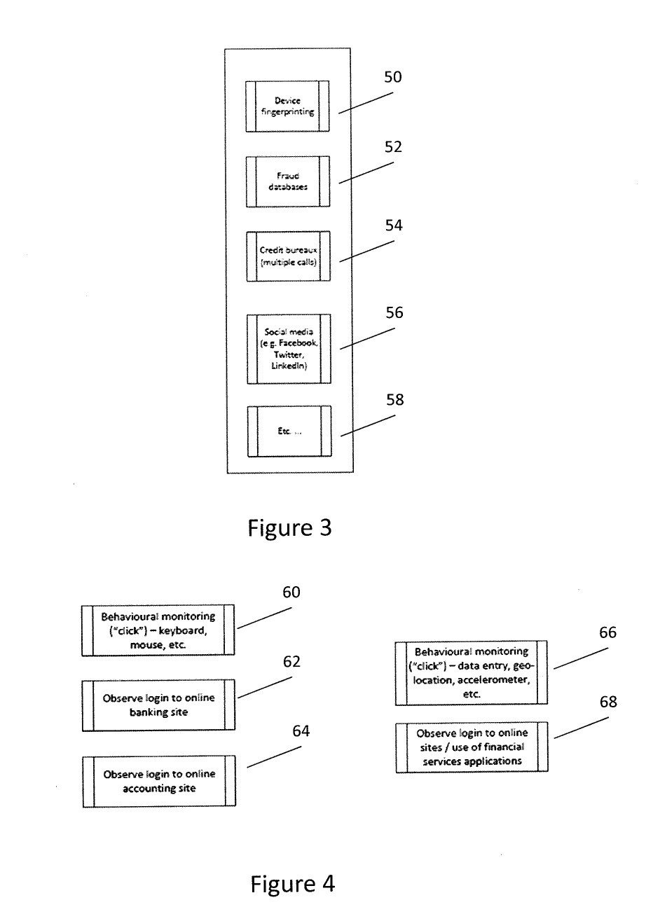

The first type of additional data relates to creditworthiness of the loan applicant. Such data includes, but is not limited to credit check data, bureau data and other external sources that provide data giving an indication of the creditworthiness of a loan applicant. Examples of this type of data are shown in FIG. 3. Data sources include device fingerprinting 50, fraud databases 52, credit bureau data 54, social media data 56 and other data sources 58. The data is related to the credit worthiness of the applicant in the sense that the data provides a credit score (such as bureau data) or provides a more direct or less direct indicator of the amount that the applicant is safely able to repay.

The decision making process is also preferrably based on at least a second type of additional data by monitoring online usage by the user of the user device. The monitoring of online usage of the user device by the user is a feature not available to offline processes including traditional bank lending decisions. Such monitoring of online usage is unique to the provision of online loans and is illustrated in FIG. 4 and includes, but is not limited to observing a login process to another system such as logging into an online bank account 62, observing transactions undertaken by applicant 64, recording the browser IP address of the user device and recording and checking input clicks undertaken by the user of the user device 60. The monitoring of online usage may also include device fingerprinting techniques such as monitoring keystrokes, coordinates clicks and other inputs. The monitoring of online usage may also be provided by monitoring other activity, particularly where the user device is a mobile device such as smartphone, tablet or wearable computing device. As shown in FIG. 4, the “click” behavioural monitoring may include other sensors within a device such as touchscreen data entry, geolocation, accelerometer or other sensors 66. One of the main types of monitoring of online usage, though, is monitoring a user while he/she logs into a third party service, such as a third party website in particular a financial service application 68.

The system of this disclosure may use a variety of techniques for monitoring online usage mentioned above, a first example of which is to instruct the applicant to log into an online bank account as part of the application process and to monitor transactions undertaken by the applicant in the online bank account. In this approach, the risk engine may use data indicating the usage of the bank account and can match this to a bank account to which the request for the loan is made. If the bank accounts are the same then a high confidence measure may be determined as part of the risk engine calculation.

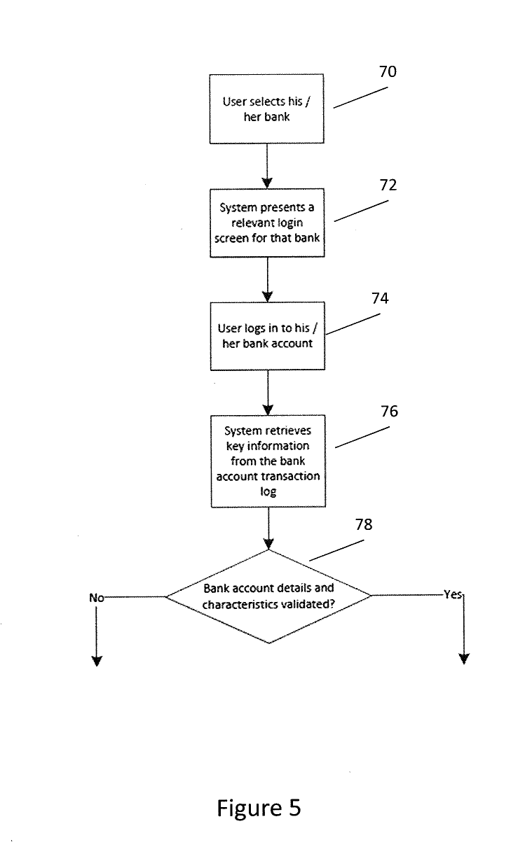

The monitoring of online usage by logging into an external service such as a bank account is shown in FIG. 5. The way in which the user device interacts with a third party such as an online provider 15 shown in FIG. 1, may be via techniques at the user device to scrape fields of data from web pages visited by the user device, or may be by an API installed at the user device, communicating with an API at the online provider 15. The monitoring may also be via an installed program or app which is arranged to retrieve data from the online activity.

As part of the online loan application process, the applicant is directed to provide the system with the required online usage by a display, pop-up or the like whether via an API, a pop-up webpage or a separate app requesting the applicant to login to their bank. At bank selection step 70, the applicant selects their bank from within a pop-up or by directing the browser to their online banking site. At login screen 72 the system presents the relevant login screen for the selected bank and at login step 74 the applicant then logs into their bank account using any appropriate security details such as password, user name, and authentication. The applicant may then operate their online bank account normally, displaying their bank details such as bank balance, transaction history and so on. While the applicant is viewing this information the system retrieves this information, in particular from the bank account transaction log at step 76. If the bank allows an API from an application on the user device, then additional information not presented to the applicant may be retrieved. At a decision step 78 a decision is made as to whether the bank account details and characteristics have been validated and a yes or no output asserted for use by the risk engine 14 in the manner previously described.

A further manner of monitoring online usage is to monitor so called “click” data. A click may be a mouse click, touch screen input or other applicant selection interaction with the user device. By monitoring such usage during the online application process various different determinations may be made. One possible determination is to process the click information to “fingerprint” an applicant in the sense that a confidence measure may be determined indicating the likelihood that the applicant is actually the stated applicant. Such an approach may reduce the risk of fraud. The applicant input data may also be used to reduce the risk that an automated machine is applying for the online loan.

Other sources of the type of data obtained by monitoring online usage of the user device are possible. The IP address of the user device informs the computer system of the location of the applicant and can be used as part of the other information provided relating to the location of the applicant as part of the decisioning process. Clicks undertaken by the applicant may also be recorded and used.

In addition to the first and second types of data discussed above, further types of data may also be used as part of the decisioning process including checking external data such as social media, browsing history and other online information related to either the user of the user device or the applicant company where the loan applicant is a company rather than the user.

Algorithms operated by the system of this disclosure will now be described in greater detail with reference to FIGS. 6 to 10.

An algorithm for producing a trust rating is shown in FIG. 6. At step 100 a request for a trust rating is received. At step 102 a determination is made whether the user for which the trust rating is requested is an existing user by referring to a user database 114. If the user is determined to be a new user (not an existing user) then at step 104 a default system trust rating is set. The system trust rating may be a value stored for the online main system. If the user is determined to be an existing user at step 102 a count of a number of previous loans provided is produced at step 106 followed by a count of successful repayments of previous loans at step 108. The count of previous loans are provided to an increment step 110 which increments the trust rating. The trust rating is then ouyput to the system at step 112.

FIG. 7 shows an algorithm for retrieving a second type of data. As previously explained, the second type of data may be a variety of types of data obtained by monitoring online usage by the user of a user device. Such online usage may include a specific request for the user to perform online activity, such as logging into an online bank account, or monitoring of online activity by looking at recorded input commands or browsing history. As a first step 120 a request is received for the second type of data. At step 122, a determination is made as to whether an online bank account is available for the user by an online question to the user or by retrieving user data. If an online bank account is determined to be available, the user is redirected to their online bank account at step 124. At step 126, the user performs steps to log into their bank account and retrieve data as directed by the system to obtain bank account validation. If online banking information is determined not to be available, the system may instead record user input commands at step 128 and retrieves browsing history at step 130 and provides this data, or data derived from this data at output data step 132.

FIG. 8 shows an algorithm for automatically determining whether to provide the requested loan. The algorithm comprises a three step test using the data related to creditworthiness, the data obtained by monitoring online usage and the trust rating. As a first step 140 the online usage data is checked, as previously described, this check may comprise verifying that the user is able to log into their online bank account. The check may also comprise monitoring of key strokes, clicks, retrieving and indication of online usage as previously mentioned. If the check fails then the process ends at step 141 and the request for the loan is declined. At step 142, a trust rating is obtained for the user. If the user is a new user, the trust rating will be a default value for the system. If the user is a repeat user, the trust rating will be derived from checks on outstanding balances on previous loans, volumes of previous loans and other previous loan behaviour. If the trust rating check fails the process ends at step 143. If the trust rating check passes, the system moves on to perform a credit data check based on external data relating to the creditworthiness of the applicant. The credit data check 144 retrieves data such as third party bureau data. If this check fails the process ends at step 145. If the credit data check passes, the determination is made to provide the loan at pass step 146.

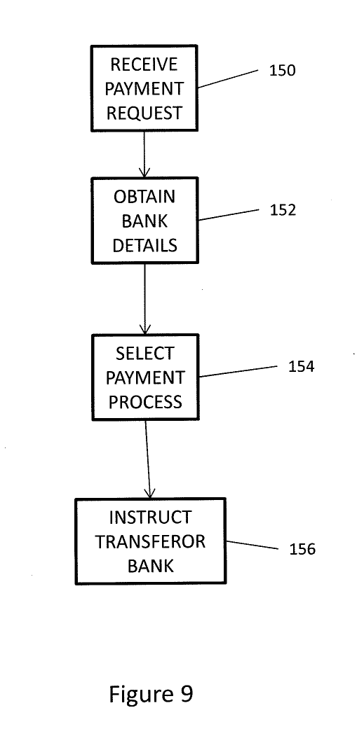

FIG. 9 shows an algorithm for instructing the sending of the loan amount. At step 150 the request for payment is received. At the next step 152, bank details for the applicant are obtained. This may be by a further request to the applicant or by retrieval of previously stored bank details for the applicant. At step 154, the payment process is selected. The payment process may vary by the identity of the recipient bank or by the country in which the system operates. For example, where the destination bank is a large national bank, the payment process selected may be to pay the loan amount from a bank account with the same bank. At step 156, the transferor bank is then instructed.

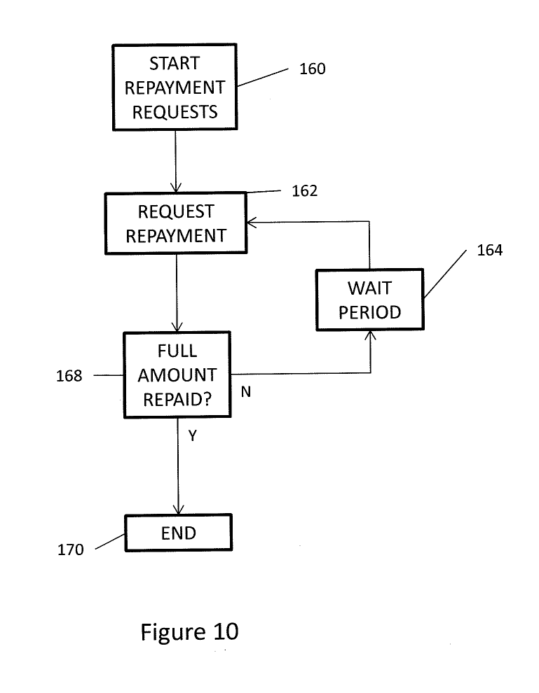

FIG. 10 shows an algorithm for initiating debit requests. At step 160, the start of repayment requests is initiated. This may be a specific period of time after the loan has been provided, on a specific date or prompted by the user. At step 162, a first request for repayment is made. This may be a request for return of the full current amount owed, or for a portion of the amount owed. At step 168, a determination is made whether the full amount has been repaid. If no, a wait period is determined at step 164, this wait period may be an agreed interval at which repayments will be requested, such as weekly or monthly. The wait period may also be determined by other factors such as a likelihood of repayment. After the wait period, a request for repayment is again made of step 162 and determination made at step 168 whether the full amount has been repaid. If the full amount has been repaid, the process ends at step 170.

The present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium.

The embodiments have been described with reference to block diagrams and flowchart illustrations of methods, apparatus (i.e., systems) and computer program products. It will be understood that each block of the block diagrams and the flowchart illustrations, and combinations of blocks in the block diagrams and combinations of the blocks in the flowchart illustrations, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block or blocks.

1. A computer system comprising one or more processors, one or more memories and one or more programs stored in one or more of the memories for execution by one or more of the processors, the system automatically determining whether to provide a loan and, if so, providing and reclaiming a loan in response to a request for a loan from a loan applicant operating a remote user device, and being programmed to carry out the following process:
receiving input data from the remote user device operated by a user comprising at least a request for a loan and an identity of the loan applicant;
producing a trust rating in response to the identity of the loan applicant;
retrieving at least a first type of external data related to the credit worthiness of the loan applicant;
retrieving at least a second type of data by monitoring online usage by the user of the user device;
automatically determining whether to provide the requested loan using at least the trust rating, the first type of external data and second type of external data;
instructing the sending of a loan amount to a bank account when requested and if the determining step determines to provide the requested loan; and
automatically initiating one or more debit requests for repayment until the loan amount has been returned.

2. The computer system of claim 1, wherein the first type of external data comprises creditworthiness data from a credit bureau.

3. The computer system of claim 1, further comprising determining a bank account number to which the requested loan is to be paid.

4. The computer system of claim 3, wherein the second type of data comprises transmitting a request to the user device for the user to log into an online bank account service related to the bank account number and monitoring online activity related to that bank account.

5. The computer system of claim 1, wherein retrieving the second type of data comprises obtaining one or more of a browser history, IP address or mouse clicks from the user device

6. The system of claim 1, wherein the input data includes one or more of a name, address, date of birth, social security number or mobile phone number of the user of the remote device.

7. The system of claim 1, wherein producing a trust rating comprises obtaining a system default value if the loan applicant is a new user of the system.

8. The system of claim 1, wherein producing a trust rating comprises obtaining a value based on previous loans provided to the loan applicant.

9. A computerized method of automatically determining whether to provide a loan and, if so, providing and reclaiming a loan in response to a request for a loan from a loan applicant operating a remote user device, comprising:
receiving input data from the remote user device operated by a user comprising at least a request for a loan and an identity of the loan applicant;
producing a trust rating in response to the identity of the loan applicant;
retrieving at least a first type of external data related to the credit worthiness of the loan applicant;
retrieving at least a second type of data by monitoring online usage by the user of the user device;
automatically determining whether to provide the requested loan using at least the trust rating, the first type of external data and second type of external data;
instructing the sending of a loan amount to a bank account when requested and if the determining step determines to provide the requested loan; and
automatically initiating one or more debit requests for repayment until the loan amount has been returned.

10. The computerised method of claim 9, wherein the first type of external data comprises creditworthiness data from a credit bureau.

11. The computerised method of claim 1, further comprising determining a bank account number to which the requested loan is to be paid.

12. The computerised method of claim 11, wherein the second type of data comprises transmitting a request to the user device for the user to log into an online bank account service related to the bank account number and monitoring online activity related to that bank account.

13. The computerised method of claim 9, wherein retrieving the second type of data comprises obtaining one or more of a browser history, IP address or mouse clicks from the user device

14. The computerised method of claim 1 wherein the input data includes one or more of a name, address, date of birth, social security number or mobile phone number of the user of the remote device.

15. The computerised method of claim 9, wherein producing a trust rating comprises obtaining a system default value if the loan applicant is a new user of the system.

16. The computerised method of claim 9, wherein producing a trust rating comprises obtaining a value based on previous loans provided to the loan applicant.

17. A non-transitory computer readable storage medium comprising program code which when executed on one or more processors, automatically determines whether to provide a loan and, if so, provides and reclaims a loan in response to a request for a loan from a loan applicant operating a remote user device, and comprising instructions to carry out the following process:
receive input data from the remote user device operated by a user comprising at least a request for a loan and an identity of the loan applicant;
produce a trust rating in response to the identity of the loan applicant;
retrieve at least a first type of external data related to the credit worthiness of the loan applicant;
retrieve at least a second type of data by monitoring online usage by the user of the user device;
automatically determine whether to provide the requested loan using at least the trust rating, the first type of external data and second type of external data;
instruct the sending of a loan amount to a bank account when requested and if the determining step determines to provide the requested loan; and
automatically initiate one or more debit requests for repayment until the loan amount has been returned.
